(19) United States
(12) Patent Application Publication
(10) Pub. No.: US 2005/0108031 A1
(43) Pub. Date: May 19, 2005

(54) Method and system for transmitting, selling and brokering educational content in streamed video form

(76) Inventor: Edwin S. Grosvenor, Bethesda, MD (US)

Correspondence Address: Pepper Hamilton LLP;Firm 21269, One Mellon Center, 50th Floor, 500 Grant Street, Pittsburgh, PA, 15219, US

(21) Appl. No.: 10/715,312

(22) Filed: Nov. 17, 2003

(51) Int. Cl. G06F 17/60

(52) U.S. Cl. 705/1

(57) ABSTRACT

A method and system of providing educational streamed video of a meeting and a method and system for brokering educational audiovisual content are disclosed. Providing the streamed video includes cataloguing the video, receiving membership and other information from a person wishing to view the video, verifying the received information, determining a fee for accessing the video, charging the fee, receiving payment of the fee, transmitting the video to the person and distributing royalty payments to one or more parties. Payments may be made to the content provider, the organization of which the person is a member, a copyright holder, and/or a presenter of the streamed video. Brokering the content includes receiving content from a first entity, permitting a person that is not a member of the first entity to access the content for a fee, charging a fee for accessing the content to the person, and receiving payment of the fee.

### FIELD OF THE INVENTION

This invention relates generally to the field of transferring audiovisual content. Specifically, this invention relates to providing methods for creating, cataloguing, and transferring educational audiovisual content over a communication network, collecting payments for the transfer of audiovisual content over a communication network, calculating payments to be made to various content owners or other parties, including by brokering the content among parties in the transaction.

### BACKGROUND

The Internet has become ubiquitous. In August 2003, an online tracking service reported that an estimated 416 million people worldwide had home Internet access. In the United States alone, approximately 182 million people have home Internet access and about 50 million people have workplace Internet access. Moreover, the data rates at which users are connecting to the Internet are increasing as well. Users requiring more bandwidth have replaced traditional dial-up modems with Digital Subscriber Lines (DSL), cable modems or other technologies. Generally, an explosion of bandwidth has occurred as the popularity of the Internet has grown.

One reason that users have increased their bandwidth is their desire to access and/or download audiovisual content. Digital photography, movies, and live or delayed camera feeds populate Internet websites today. As increased recognition of the benefits of accessing such files occurs, more users will utilize high-speed connections to access the Internet.

Many Internet users that currently possess high-speed connections are in the corporate sector. Businesses with many employees or businesses that develop leading-edge technology products often use one or more T-1 or T-3 lines to connect to the Internet.

Businesses continuously attempt to reduce costs while trying to provide the highest quality products or services for their customers and a suitable work environment for their employees. Most businesses would prefer to reduce their educational training costs, especially if doing so would not compromise the quality of the training. In the past, attending industry-wide conferences has been an accepted method for professionals to gain industry knowledge. However, recent attendance figures for a group of industry-wide conferences indicate that 5.6% of the sponsoring organization's total membership attends a typical annual conference. Percentages are even lower for meetings that are not the annual conference. Such low attendance may result from companies trying to meet their bottom lines since the cost of attending a non-local conference may be prohibitive for a company, especially if numerous employees wish to attend, or it may result from individuals not being able to afford the cost of attending.

Other factors that may have caused member attendance at industry-wide conferences to decrease in recent years include the general economic climate, layoffs, terror threats and a general perception of the increased inconvenience of travel may have each contributed to the decrease in member attendance. Many professionals find that conflicts with other obligations prevent them from attending conferences that they would like to attend. Even when a professional attends a conference, conflicting sessions or session tracks may prevent the professional from attending a session of interest. As a result, professionals may not receive important professional training that they need.

In addition, the organizers of these meetings may not generate sufficient revenue from a lightly attended conference to support their operations. One recent study by the American Society of Association Executives found that while meetings were the second highest source of non-dues revenue for member associations, the associations reported an average loss of $100,300 on meetings and conferences for 2002. Accordingly, a significant need exists for developing a method to increase revenues.

Currently, at least 7,400 major trade associations, professional societies, labor unions and similar national groups exist in the United States. Some of these associations, such as the American Bar Association and the American Nurses Association, offer professional development opportunities, the ability to share ideas across companies, forum building, and lobbying direction for industries. Other associations provide an opportunity for people with similar interests to discuss their interests with others of like mind, such as the Mathematical Association of America or the Experimental Aircraft Association.

In many industries in the United States, a national or international organization provides training for its members by sponsoring an industry-wide conference. However, in many cases it is state or local organizations, rather than national or international organizations, that certify members as professionals in good standing. Thus, a member may attend a national conference in order to receive professional development training, but be required to report back to his or her local organization in order to receive credit for his or her continuing education.

Associations sponsoring conferences are generally desirous of new revenue streams to supplement revenue earned from conference attendance fees and to expand their services to help retain existing members and gain new members. A pay-as-you-go system of disseminating conference content can help defray the cost of producing and marketing the content. In addition, many associations are interested in disseminating information to people or organizations that are non-members, such as those in related disciplines or those who would not otherwise have the opportunity to attend association conferences. Interested non-attendees may include an international body of professionals working in the same discipline as members of a national association. Thus, a pay-per-view system can play an important role in the dissemination of critically needed professional knowledge to broader audiences by helping to pay for the costs of producing and distributing the streamed video content, which conference organizers might not otherwise be able to do.

Currently, little incentive exists for an organization to promote content from another organization to its members. Organizations generally generate money from attendance at seminars and conferences that they sponsor. Since no method currently exists for generating revenue from promotional efforts directed to other organizations' conferences, an organization is unlikely to inform its members of such conferences. As a result, members of non-sponsoring organizations are often ignorant of opportunities to expand their knowledge base by accessing information from other related disciplines.

Streamed video, such as webcasting or cable or satellite television network programming, can be used to allow conference sessions to reach a larger audience than those attending the conference in person. However, providers are currently limited in the functionality that they can provide to users. For instance, no central repository of webcasts for different market segments currently exists. In addition, potential viewers may only select individual webcasts or pre-defined packages of webcasts for viewing. Webcast providers do not have a flexible pricing mechanism for the selective viewing of webcasts allowing for either single purchases, subscriptions for a conference track or theme, subscriptions for the entire conference content, or subscriptions to everything offered by the association or conference organizer. Webcast providers also do not provide multiple revenue streams to associations as an inducement for the associations to list their content on a webcast provider's website. Moreover, webcast providers do not aggregate and offer for sale content from multiple content owners, nor do they put such content into orderly categories and hierarchical structures so that a variety of content on a single subject can be quickly found. Existing webcast providers generally do not generally provide biographical information regarding the presenter(s), instructor(s), moderator(s) or panelist(s) of a specific webcast. Webcast providers do not offer the option of providing streaming text concurrently with a webcast, in part to meet the requirements of hearing-impaired viewers. Furthermore, webcast providers do not provide information to search engines and other online distributors to encourage people to access webcasts.

Thus, a need exists for new methods of providing access to educational audiovisual content in an efficient, effective and commercially attractive manner.

A further need exists for methods of brokering access rights to audiovisual content between different content-producing entities and their members or employees.

It is a goal of the present invention to solve one or more of the problems described above.

### SUMMARY

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “content provider” is a reference to one or more content providers and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

The present invention facilitates the sale and brokering of continuing education for organizations and associations. Associations, in general, are looking to expand their markets for professional development. For example, a national organization of nurses may want to sell information to Colorado nurses, Texas nurses, etc. While the nurses may be desirous of receiving the information presented at the national meeting, they may not be informed of the meeting because their state or local chapters have no incentive to market the national conference to their members. Moreover, the nurses may not be able to attend the conference because of insufficient funding, safety concerns, layoffs, and the like. The present invention provides a monetary incentive for local chapters to encourage their members to access video content stored by the national association, and permits members to engage in distance learning at low cost.

In a preferred embodiment, a method of providing educational streamed video of a meeting includes cataloguing educational audiovisual content of a meeting of a first organization from a first content provider, receiving membership information for a person seeking to access at least a portion of the educational audiovisual content, verifying a membership status of the person based on the membership information, determining a fee based on at least one of a level of service requested by the person and the membership status of the person, verifying payment of the fee by the person, transmitting a streamed video of the educational audiovisual content to the person, and distributing royalty payments to the appropriate parties. In an embodiment, the method includes receiving the educational audiovisual content of a meeting of the first organization from the first content provider. The first content provider may be selected from a group including trade associations, professional organizations, trade unions, membership organizations, trade show organizers, research or consulting firms, industry analysts, non-profit organizations, universities, government agencies and businesses.

In an embodiment, cataloguing the content includes receiving information regarding educational audiovisual content, organizing the educational audiovisual content into groups based on the content provider, organizing each group of educational audiovisual content into sub-groups, organizing each sub-group into tracks, and organizing each track into elements. Each sub-group corresponds to a conference operated by the corresponding content provider. Each track corresponds to related sessions at a corresponding conference. Each element corresponds to a session of the corresponding track. In a further embodiment, the requested level of service may be selected from one or more of an element; a plurality of elements; a track; a plurality of tracks; a sub-group; a plurality of sub-groups; a group, and a plurality of groups. In an embodiment, the requested level of service is selected from the group consisting of a session of a meeting; a session track of a meeting; a meeting; and all meetings provided by a content provider during a subscription period. In an embodiment, cataloguing the content includes assigning metadata corresponding to one or more of the subject matter of the educational audiovisual content, transmission-related information of the educational audiovisual content, one or more presenters, introducers, moderators or panelists of the educational audiovisual content, and the first content provider.

In an embodiment, the person is a member of the first organization. Verifying a membership status may include determining whether the person is a member of the first organization by, for example, determining whether the person is an active member of the first organization or determining a level of membership for the person. Verifying membership status may be done by, for example, accessing a database containing information regarding the membership of the first organization or receiving a password assigned to one or more members of the first organization.

In an embodiment, verifying payment of the fee includes processing a credit card transaction. In an embodiment, distributing royalty payments includes paying a royalty fee to the first content provider, one or more presenters, introducers, moderators or panelists of the educational audiovisual content, one or more copyright holders of the educational audiovisual content, or the first organization.

In an embodiment, the person purchasing the content is a member of a second organization. Verifying a membership status may include determining whether the person is a member of the second organization by, for example, determining whether the person is an active member of the second organization or determining a level of membership for the person. Verifying a membership status may be done by, for example, accessing a database containing information regarding the membership of the second organization or receiving a password assigned to one or more members of the second organization. In an embodiment, distributing royalty payments includes paying a royalty fee to the second organization.

In an embodiment, transmitting a streamed video includes sending the educational audiovisual content at a later requested time. In an alternate embodiment, transmitting a streamed video includes sending the educational audiovisual content substantially at a time at which the person requests the educational audiovisual content. In an embodiment, transmitting a streamed video includes providing a link to a database providing at least biographical information for one or more presenters in the streamed video. In an embodiment, transmitting a streamed video includes transmitting the streamed video over one or more of a computer network, a digital or analog cable network, or a satellite network.

In a preferred embodiment, a method of brokering educational audiovisual content includes receiving educational audiovisual content from a first entity, permitting access to the educational audiovisual content to one or more persons for a fee, charging the fee to a person who accesses at least a portion of the educational audiovisual content from the first entity, and receiving payment of the fee. The method may further include paying a portion of the fee payment to the first entity, one or more presenters, introducers, moderators or panelists of the educational audiovisual content, or one or more copyright holders of the educational audiovisual content. In an embodiment, the person is a member of a second entity. In a further embodiment, the method includes paying a portion of the fee payment to the second entity.

In a preferred embodiment, a system for providing educational streamed video of a meeting includes a processor, a computer-readable media operatively coupled to the processor, and a communication port. The computer-readable media contains instructions for performing a method of providing educational streamed video of a meeting including cataloguing educational audiovisual content of a meeting of a first organization from a first content provider, receiving, via the communication port, membership information for a person seeking to access at least a portion of the educational audiovisual content, verifying a membership status of the person based on the membership information, determining a fee based on at least one of a level of service requested by the person and the membership status of the person, verifyng payment of the fee by the person, distributing royalty payments, and transmitting, via the communication port, a streamed video of the educational audiovisual content to the person.

In a preferred embodiment, a system for brokering educational audiovisual content includes a processor, a computer-readable media operatively coupled to the processor, and a communication port. The computer-readable media contains instructions for implementing a method of brokering educational audiovisual content including receiving educational audiovisual content from a first entity, permitting access, via the communication port, to the educational audiovisual content to one or more persons for a fee, charging the fee to a person who accesses at least a portion of the educational audiovisual content from the first entity, and receiving payment of the fee.

### BRIEF DESCRIPTION OF THE DRAWINGS

Aspects, features, benefits and advantages of the embodiments of the present invention will be apparent with regard to the following description and the accompanying drawings where:

FIG. 1 depicts a flow diagram for an exemplary method of transmitting educational streamed video of a meeting according to an embodiment of the present invention.

FIG. 2 depicts a flow diagram for an exemplary method of brokering payment for an educational streamed video of a meeting according to an embodiment of the present invention.

FIG. 3 is a block diagram of exemplary internal hardware that may be used to contain or implement the program instructions of a system embodiment of the present invention.

### TERMINOLOGY

Webcasting, as used herein, is defined as the use of the Internet to broadcast live or delayed audio and/or video transmissions. As such, webcasting is much like traditional television and radio broadcasts except that the transmissions are performed over the Internet. In addition, a webcast may include background information or interactive elements, such as a chat room or a question/response area, in which the viewer may interact with or learn more about the instructor or the information conveyed in the webcast.

### DETAILED DESCRIPTION

The present invention relates to providing methods for creating, cataloguing, and transferring educational audiovisual content over a communication network, collecting payments for the transfer of audiovisual content over a communication network, calculating payments to be made to various content owners or other parties, possibly by brokering the content among parties in the transaction, and certifying that viewers of audiovisual content over a communication network viewed the content.

Educational audiovisual content of a meeting may be presented to interested parties who are not informed about a meeting or are otherwise unable to attend the meeting when it occurs. The content may include, for example, a video of a session at the meeting, one or more slides or other downloadable documents that were either presented at the session or have been subsequently added to supplement the material presented, biographies and/or photos of the session presenter(s), surveys, polls, questions, and/or facts pertaining to the topic of the session discussion, and/or surveys regarding the viewers of the content. If the session is viewed remotely, the content may further include the ability to interactively participate in the session by forwarding questions or responses to the presenter.

The information described above may be presented to a viewer in a format unique or distinctive to a particular presenter, meeting or content provider. The content provider may assign session-specific policies that determine, for example, the number of times a paying viewer may access the content, the length of time over which it may be viewed, and pricing discounts for particular people or members of particular organizations.

In order to produce the audiovisual content, audio and video recordings are made of a meeting. In an exemplary embodiment, a content provider, an organization sponsoring the meeting, or a streamed video distributor may make the recordings. The streamed video distributor may then receive and encode the recordings for various compression rates and convert visual aids (such as PowerPoint® slides) presented during the meeting to individual graphic images. A player or “skin” may be created in which the viewer sees the video, audio and other content displayed and synchronized together over a period of time. This skin may be uniquely designed for the content provider or sponsoring organization. Metadata may then be created for the educational content. The metadata may include titles and subtitles, conference name, descriptions of the content, a table of contents, presenter names and biographies, highlighted keywords and metatags. The content may then be placed in ordered categories in hierarchical structures to permit easy searching for the content. The points or nodes in these hierarchies may function as Uniform Resource Locators (URLs) or other file indicators which can allow distributing or affiliate websites to point specifically to content of interest for users of their website. Thus, for example, a nurses association could point to URLs that provide content in categories of particular interest to nurses, as well as other health or medical categories.

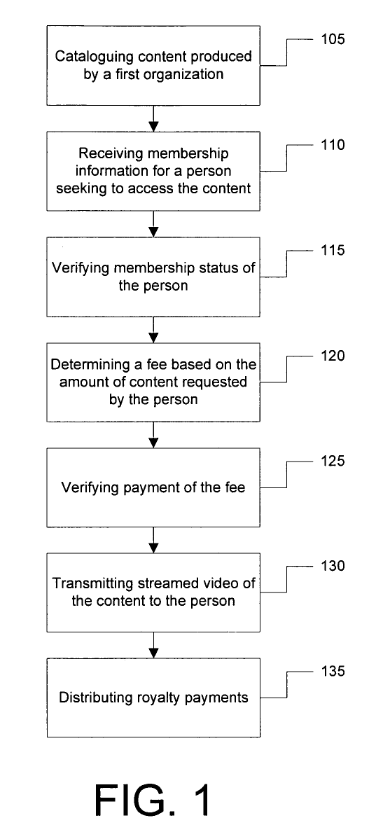

FIG. 1 depicts a flow diagram for an exemplary method of transmitting educational streamed video of a meeting according to an embodiment of the present invention. Educational audiovisual content of a meeting may initially be catalogued 105. Cataloguing the content 105 may include creating data about the content such as information about the content provider, the organization which sponsored a meeting, the speaker(s), introducer(s), moderator(s), panelist(s), or other participants involved in presenting the information in the content, the price for members and non-members, the length of time elapsing while viewing, links to research or other information available to viewers, a site where the presenter(s) documents may be downloaded, or any other attribute of the content. A repository from which a user can request the content may receive the content in the process of cataloguing the content 105. Alternatively, the content provider or distributing organization may retain the content locally and provide the repository with a link to the content. The first content provider may include, without limitation, a trade association, a professional organization, a trade union, a membership organization, a trade show organizer, a market research firm, an industry or financial analyst, a motivational speaker, trainer, provider of knowledge in a multiplicity of professions such as accounting, agriculture, law, or health, or a business or any combination thereof.

In an exemplary embodiment, cataloguing the educational audiovisual content 105 may include organizing the content into categories relating to the fields of the organization that supplied the content. The content may be further organized into sub-groups based on the particular meeting at which the audiovisual content was produced. The content may be further organized into tracks based on a session track (a grouping of sessions related by, for example, topic, speaker, or any other common feature) at the meeting at which the audiovisual content was produced. The content may be still further organized into elements based on the particular session of the meeting at which the audiovisual content was produced. By organizing the content in this manner, a viewer may more easily access particular content. Moreover, the organization may permit different levels of service to be provided to a viewer. For instance, different levels of service may include, without limitation, viewing a single element (i.e., a session of a meeting), a plurality of elements, a track (i.e., a session track or series of sessions), a plurality of tracks, a sub-group (i.e., a meeting), a plurality of sub-groups, a group (i.e., a content provider's meetings), or a plurality of groups. Preferably, the viewer may view content in some or all of these levels of service on demand or pay-per-view.

In an embodiment, cataloguing the educational audiovisual content 105 may include assigning metadata corresponding to, for example, the subject matter of the content, transmission-related information for the content, a list of presenters for the content, and the content provider. Metadata is information assigned to content that a viewer may not normally view while watching the content. Metadata may improve the ability to locate content by providing information that a potential viewer can use to search for the content.

Cataloguing the educational audiovisual content 105 may allow a viewer to search the repository's content for particular content matching search criteria. For example, a viewer may search for content by topic, by presenter, by conference, by conference organizer, or by any other criteria maintained in the database. In addition, a global search based on keywords may be performed. The searching operation may be performed on a database containing content-related information, such as metadata including the topic, the conference organizer, the presenter names, a description of the content, tables of contents, a description of Continuing Education Unit credits that may be offered for completed viewing of the content, information about the organization offering the certification that may be different from the conference organizer, and other information. The database may be stored on a server connected to a communication network, such as the Internet, an intranet, a digital or analog cable television network, a satellite television network, or any other communication network.

Membership information may be received 110 from a potential viewer who wishes to access at least a portion of the content provided by a first organization. The viewer may be a member of the content-providing organization, another organization, or the general public. The membership information may allow identification of the viewer as a member of a particular organization. If the viewer is identified as a member of a previously designated organization, such as, for example, the content-providing organization, the viewer may be able to view the content for a reduced fee.

The membership information may be verified 115 to determine whether the viewer is a member in good standing of an organization. The viewer may be identified as a member of an organization by, for example, accessing a database containing information about members of an organization. The information may include, for example, a level of membership of the viewer and whether the viewer is currently active in the organization. Active status may be determined based upon whether the viewer has paid dues for the current time period. Alternatively, the viewer may supply a password assigned to members of an organization or to the particular viewer.

After the viewer has been identified as a member of a particular organization, a fee may be determined 120 for accessing the content requested by the viewer. The determination of the fee 120 may be based on a level of service requested by the viewer. In other words, the fee may be based on whether the viewer requests to view one or more sessions of a meeting, one or more meetings provided by an organization, or meetings of one or more organizations. The fee may be determined based on the viewer's membership status in one or more pre-designated organizations for which discounted fees are provided.

The fee payment may then be verified 125 to permit access to the content by the viewer. The verification 125 may include a credit or debit card payment verification process, particularly if the payment is made remotely, such as over the Internet, an intranet, a digital or analog cable television network or a satellite television network.

The content may then be transmitted 130 to the requesting viewer in a streamed video format. The content may be transmitted 130 at a time designated by the viewer, such as immediately upon payment, at a later time that the viewer requests at the time of payment, or at a time that the viewer later requests. The transmission 130 of the streamed video may occur over, for example, a communication network, such as the Internet, an intranet, a digital or analog cable television network, a satellite television network, or any other communication network.

Once the fee payment is received, royalty payments may be distributed 135. Royalty fees may be paid 135 to one or more people or groups including, without limitation, a content provider, a content presenter (i.e., the original presenters of the session at the meeting), a copyright holder of the content, an organization which sponsored the meeting, an organization of which the viewer is a member, an entity that facilitated the transaction such as an entity providing association management software to an organization, or any combination thereof.

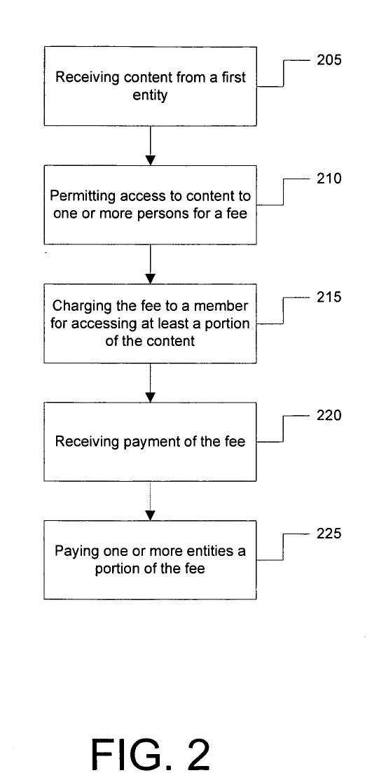

FIG. 2 depicts a flow diagram for an exemplary method of brokering payment for an educational streamed video of a meeting according to an embodiment of the present invention. Initially, educational audiovisual content may be received 205 from an entity. The content may be received by transmission over a computer network, such as the Internet, an intranet or a combination thereof, or in a tangible format, such as an optical disc, a compact disc, a DVD, a videocassette, or any other audiovisual or data-storing media. Upon receipt of the content, access may be permitted 210 to one or more members of an entity other than the providing entity for a fee. The fee may be charged 215 to a member of the entity that did not provide the content for accessing at least a portion of the content. The charged fee may depend on, for example, the extent of the content requested by the viewing member or the entity to which the viewing member belongs. Payment of the particular fee may then be received 220.

Optionally, a portion of the particular fee may be apportioned 225 to one or more groups or people including, without limitation, the providing entity, the entity to which the member belongs, one or more presenters of the educational audiovisual content, or one or more copyright holders of the educational audiovisual content.

The preferred architecture for the system includes an online database accessible by any computer user who has an Internet connection and a browser of recent issue. A user may search for content using a sophisticated search-and-retrieval system that allows the user to locate content grouped dynamically in multiple subject areas and also by title, content owner, conference, or conference series. The user may also search the database using multiple input parameters that are “enabled” with Boolean logic. Thus, for example, a user who inputs “presenter=‘McCord’” in the first parameter and “subject=‘Perioperative nursing’” in the second would generate a results set listing records of audiovisual content presented about perioperative nursing by someone named “McCord.” Further, a preferred architecture for the system includes a system to create audiovisual content that allows a content distributor to encode video and audio into multiple bit rates for transmission to users with differing levels of bandwidth. This system may convert the presenters' slides, such as PowerPoint® files, into single, compressed graphic images, and integrate the audio and video streams over time with these and other graphic components into a “player” or “skin.” A user with Windows Media Player created by Microsoft Corporation or RealOne Player distributed by RealNetworks, Inc. can view the player as it displays the video and audio streams. The player may also include multiple links to data in the system's database regarding 1) the names of the one or more presenters, introducers, moderators, and/or panelists, 2) brief biographies and/or photos of these individuals, 3) links to available research by these individuals, 4) the logo of the organization owning the content, 5) a hyperlinked table of contents that allows the user to quickly and easily navigate to a multiplicity of time points in the program, 6) a box for users to pose questions to the one or more presenters and view answers to the questions that have been posed by all viewers, and 7) a box for facts, trivia, or interactive surveys and polls sent automatically to viewers as they watch the programs. Further, the preferred architecture for the system may allow a user to register personal information in the system to maintain data on the user over time. The architecture may allow the user to purchase content using a credit card in a secure environment employing, for example, Secured Socket Layer encryption and other appropriate electronic commerce technology. In a preferred architecture for the system, the terms and conditions for accessing the audiovisual content may be flexibly set for individual content files by the owner of the content with regard to, for example, price, the number of times the content can be viewed, the length of time over which it can be viewed, and the like. The system may allow for different pricing based on membership status in certain organizations and may calculate royalties owed to various parties related to the transaction. The system may provide clients with data regarding actual viewing of content by users to ensure that viewing had been completed in order to issue Continuing Education credits to the users.

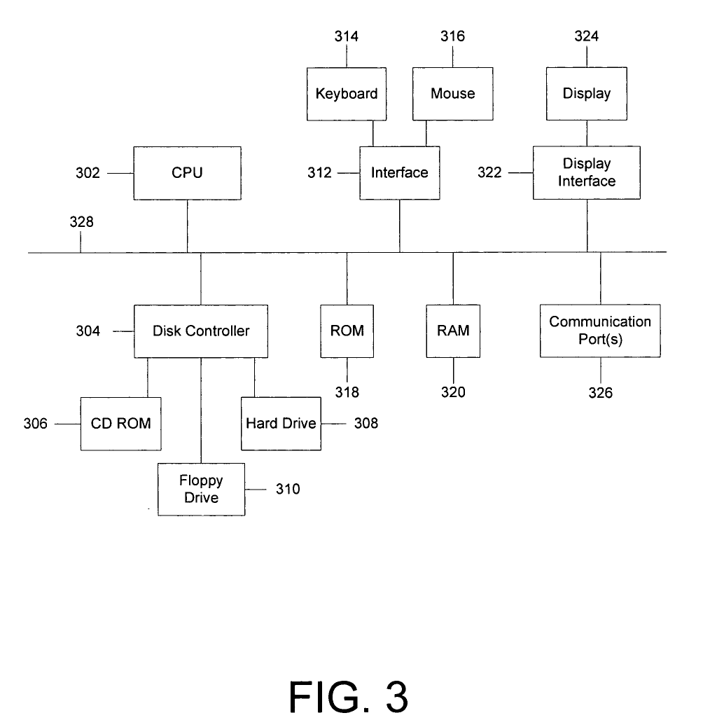

FIG. 3 is a block diagram of exemplary internal hardware that may be used to contain or implement the program instructions of a system embodiment of the present invention. Referring to FIG. 3, a bus 328 serves as the main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be external or internal floppy disk drives such as 310, CR ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports such as 326.

In addition to the standard computer-type components, the hardware may also include an interface 312 which allows for receipt of data from input devices such as a keyboard 314 or other input device 316 such as a remote control, pointer and/or joystick.

The communication ports 326 may connect the internal hardware system to a video distribution network, such as the Internet, an intranet, a digital or analog cable television network, a satellite television network, or any other video distribution system capable of delivery of educational audiovisual content. Preferably, the video distribution system implements a browser that allows the viewer to perform operations such as searching, payment processing, and other operations. Preferably, the video distribution system is capable of delivering educational audiovisual content on demand or pay-per-view.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method of providing educational streamed video of a meeting, comprising:
cataloguing educational audiovisual content of a meeting of a first organization from a first content provider;
receiving membership information for a person seeking to access at least a portion of the educational audiovisual content;
verifying a membership status of the person based on the membership information;
determining a fee based on at least one of a level of service requested by the person and the membership status of the person;
verifying payment of the fee by the person;
transmitting a streamed video of the educational audiovisual content to the person; and
distributing royalty payments.

2. The method of claim 1, further comprising:
receiving the educational audiovisual content of a meeting of the first organization from the first content provider.

3. The method of claim 1 wherein the first content provider is selected from a group including trade associations, professional organizations, trade unions, membership organizations, trade show organizers, research or consulting firms, industry analysts, non-profit organizations, universities, government agencies and businesses.

4. The method of claim 1 wherein cataloguing comprises:
receiving information regarding educational audiovisual content;
organizing the educational audiovisual content into groups based on the content provider;
organizing each group of educational audiovisual content into sub-groups, wherein each sub-group corresponds to a conference operated by the corresponding content provider;
organizing each sub-group into tracks, wherein each track corresponds to related sessions at a corresponding conference; and
organizing each track into elements, wherein each element corresponds to a session of the corresponding track.

5. The method of claim 4 wherein the requested level of service is chosen from one or more of an element; a plurality of elements; a track; a plurality of tracks; a sub-group; a plurality of sub-groups; a group; and a plurality of groups.

6. The method of claim 1 wherein the requested level of service is selected from the group consisting of a session of a meeting; a session track of a meeting; a meeting; and all meetings provided by a content provider during a subscription period.

7. The method of claim 1 wherein cataloguing comprises assigning metadata corresponding to one or more of the subject matter of the educational audiovisual content;
transmission-related information of the educational audiovisual content; one or more presenters, introducers, moderators or panelists of the educational audiovisual content; and the first content provider.

8. The method of claim 1 wherein the person is a member of the first organization.

9. The method of claim 1 wherein verifying a membership status comprises determining whether the person is a member of the first organization.

10. The method of claim 9 wherein determining whether the person is a member of the first organization comprises determining whether the person is an active member of the first organization.

11. The method of claim 9 wherein determining whether the person is a member of the first organization comprises determining a level of membership in the first organization for the person.

12. The method of claim 9 wherein determining whether the person is a member of the first organization comprises accessing a database containing information regarding the membership of the first organization.

13. The method of claim 9 wherein determining whether the person is a member of the first organization comprises receiving a password assigned to one or more members of the first organization.

14. The method of claim 1 wherein verifying payment of the fee comprises processing a credit or debit card transaction.

15. The method of claim 1 wherein distributing royalty payments comprises paying a royalty fee to the first content provider.

16. The method of claim 1 wherein distributing royalty payments comprises paying a royalty fee to one or more presenters, introducers, moderators or panelists of the educational audiovisual content.

17. The method of claim 1 wherein distributing royalty payments comprises paying a royalty fee to one or more copyright holders of the educational audiovisual content.

18. The method of claim 1 wherein distributing royalty payments comprises paying a royalty fee to the first organization.

19. The method of claim 1 wherein the person is a member of a second organization.

20. The method of claim 19 wherein verifying membership information comprises determining whether the person is a member of the second organization.

21. The method of claim 20 wherein determining whether the person is a member of the second organization comprises determining whether the person is an active member of the second organization.

22. The method of claim 20 wherein determining whether the person is a member of the second organization comprises determining a level of membership in the second organization for the person.

23. The method of claim 20 wherein determining whether the person is a member of the second organization comprises accessing a database containing information regarding the membership of the second organization.

24. The method of claim 20 wherein determining whether the person is a member of the second organization comprises receiving a password assigned to one or more members of the second organization.

25. The method of claim 19 wherein distributing royalty payments comprises paying a royalty fee to the second organization.

26. The method of claim 1 wherein transmitting a streamed video comprises sending the educational audiovisual content at a later requested time.

27. The method of claim 1 wherein transmitting a streamed video comprises sending the educational audiovisual content substantially at a time at which the person requests the educational audiovisual content.

28. The method of claim 1 wherein transmitting a streamed video comprises providing a link to a database providing at least biographical information for one or more presenters in the streamed video.

29. The method of claim 1 wherein transmitting a streamed video comprises transmitting the streamed video over a computer network.

30. The method of claim 1 wherein transmitting a streamed video comprises transmitting the streamed video over a cable network.

31. The method of claim 1 wherein transmitting a streamed video comprises transmitting the streamed video over a satellite network.

32. A method of brokering educational audiovisual content, comprising:
receiving educational audiovisual content from a separate first entity;
permitting access to the educational audiovisual content to one or more persons for a fee;
charging the fee to a person who accesses at least a portion of the educational audiovisual content; and
receiving payment of the fee.

33. The method of claim 32, further comprising paying a portion of the fee payment to the first entity.

34. The method of claim 32 wherein the person is a member of a second entity.

35. The method of claim 34, further comprising paying a portion of the fee payment to the second entity.

36. The method of claim 32, further comprising paying a portion of the fee payment to one or more presenters, introducers, moderators or panelists of the educational audiovisual content.

37. The method of claim 32, further comprising paying a portion of the fee payment to one or more copyright holders of the educational audiovisual content.

38. A system for providing educational streamed video of a meeting, comprising:
a processor;
a computer-readable media operatively coupled to the processor; and
a communication port,
wherein the computer-readable media contains instructions for performing a method of providing educational streamed video of a meeting, the method comprising:
cataloguing educational audiovisual content of a meeting of a first organization from a first content provider,
receiving, via the communication port, membership information for a person seeking to access at least a portion of the educational audiovisual content,
verifying a membership status of the person based on the membership information,
determining a fee based on at least one of a level of service requested by the person and the membership status of the person,
verifying payment of the fee by the person,
transmitting, via the communication port, a streamed video of the educational audiovisual content to the person,
distributing royalty payments.

39. A system for brokering educational audiovisual content, comprising:
a processor;
a computer-readable media operatively coupled to the processor;
a communication port,
wherein the computer-readable media contains instructions for implementing a method of brokering educational audiovisual content, the method comprising:
receiving educational audiovisual content from a first entity,
permitting access, via the communication port, to the educational audiovisual content to one or more persons for a fee,
charging the fee to a person who accesses at least a portion of the educational audiovisual content from the first entity, and
receiving payment of the fee.
